(19) United States
(12) Patent Application Publication
(10) Pub. No.: US 2025/0064662 A1
(43) Pub. Date: Feb. 27, 2025

(54) PELVIC FLOOR MUSCLE STRENGTHENING DEVICE

(71) Applicant: FURUN HEALTHCARE CO., LTD., Wonju-si (KR)

(72) Inventor: Byoung Mo KANG, Wonju-si (KR)

(21) Appl. No.: 18/723,396

(22) PCT Filed: Jan. 21, 2022
(86) PCT No.: PCT/KR2022/001125

§ 371 Date: Jun. 21, 2024

(30) Foreign Application Priority Data
Jan. 19, 2022 (KR) 10-2022-0007910

(51) Int. Cl. A61H 1/02; A61H 7/00

(52) U.S. Cl. CPC A61H 1/0244; A61H 7/004; A61H 2201/10; A61H 2201/1633; A61H 2201/1664; A61H 2201/501; A61H 2201/5043; A61H 2201/5071; A61H 2203/0431; A61H 2230/805

(57) ABSTRACT

The invention is a pelvic floor muscle strengthening device capable of training the pelvic floor muscles inside the body while wearing clothes and exercising in an optimal state according to the body information of the user, and includes a seat body 11, a bearing element 20 to push the pelvic floor muscle P upward, a press-adjusting means 21, detecting means 35, an electric circuitry 42, an input means 40 and a control module 45, and is operated in the manner that if the user's body weight increases, the force or compression pressing on the pelvic floor muscle P also increases.

### TECHNICAL FIELD

The present invention relates to a pelvic floor muscle strengthening device, and more particularly to a pelvic floor muscle strengthening device capable of training the pelvic floor muscles inside the body even in a state of wearing clothes and enable of muscle strengthening exercise in an optimal state according to the body information of the user.

### BACKGROUND ART

A pelvic floor muscle is a muscle tissue including an anus and a urethral sphincter positioned under the pelvis, and the typical disease due to weakening of the pelvic floor muscle is a urinary incontinence. The urinary incontinence is a symptom that the pelvic floor muscle is lengthened due to pregnancy and childbirth, and it becomes worse as woman gets old so that it cannot support the organs such as a bladder, a rectum and others properly and sags downward. Therefore, the treatment of the urinary incontinence is to keep on a contracting exercise of the pelvic floor muscle to restore the muscle power to support the organs such as bladder properly.

For the effective contracting exercise of the pelvic floor muscle, the degree of contraction should be known, but conventionally, there is no way to directly detect the contracting force of the pelvic floor muscle, so the indirect method of exercising for the pelvic floor muscle is used in which a small device is inserted into the vagina of woman and the tightening force of the sphincter is detected, then the target muscle of the pelvic floor muscle is also exercised accordingly. That is, as the pelvic floor muscle, together with the anal sphincter and the urethral sphincter, is connected to the pudendal nerve, if these sphincters contract, then the pelvic floor muscle also contracts, which results in the exercise of pelvic floor muscle.

But the above-mentioned insert-type device has a problem that woman should undress and insert it into the vagina, which is very inconvenient and may arouse a humiliation. And, to strengthen the weak muscle, the muscle should be exercised by contracting against the external resistance such as an exercise with holding a dumbbell, and the exercise of pressing a particular part of the body without external resistance is hard to achieve any substantial muscle exercise effect. But in the conventional insert-type device, any external resistance cannot be applied in the sensitive vagina to exercise, that is, it is a non-resistance exercise, so inevitably the muscle power restoring effect is low.

### DISCLOSURE

### Technical Problem

The invention is proposed to solve the above-mentioned problems, and the object of the invention is to provide a pelvic floor muscle strengthening device capable of training the pelvic floor muscles inside the body even in a state of wearing clothes and enable of muscle strengthening exercise on the optimal condition of external resistance such that the external resistance is proportional to the weight of the pelvic organs of the user and is inversely proportional to the pain causing probability, so that exercise of pelvic floor muscle is possible under the optimized external resistance.

### Technical Solution

According to an aspect of the invention, there is provided a pelvic floor muscle strengthening device comprising:
a seat body 11 to be sat by a user;
a bearing element 20 provided on the seat body 11 and having a slender shape to be sat by the user to push the pelvic floor muscle P upward through the narrow perineal region between the buttocks of the user;
a press-adjusting means 21 to adjust the force or the compression to press the pelvic floor muscle P of the user through the bearing element 20;
a detecting means 35 connected to the bearing element 20 to detect the force or compression by the bearing element 20 against the pelvic floor muscle P or the force or compression increased by user's contracting of the pelvic floor muscle P;
an electronic circuitry 42 connected to the detecting means 35 and transmitting data of the increased force or compression according to contraction of the pelvic floor muscle P of the user to a display means 60 to display visually or audibly;
an input means 40 to input the information of the user's body weight;
a control module 45 to receive the information of the user's body weight and generate a control signal to increase the force or compression applied on the pelvic floor muscle P in proportion to the user's body weight, so that;
the device is operated in the manner that if the user's body weight increases, the weight of the pelvic organs also increases proportionally, so the force or compression pressing on the pelvic floor muscle P also increases to achieve more effective contracting exercise.

According to the other aspect of the invention, there is provided a pelvic floor muscle strengthening device, wherein the input means 40 can be input an information of user's body height, and the control module 45 can generate a control signal which, if the user's body height increases, the force or compression pressing on the pelvic floor muscle P is reduced inverse-proportionally.

According to another aspect of the invention, there is provided a pelvic floor muscle strengthening device, wherein the press-adjusting means 21 comprises of an inclined surface 22 of the bearing element 20 which is inclined longitudinally, so that as the user moves the sitting position longitudinally, the pressing intensity of the bearing element 20 can be adjusted.

According to another aspect of the invention, there is provided a pelvic floor muscle strengthening device, wherein the press-adjusting means 21 includes a lifting means 30 of the bearing element 20, which can move the bearing element 20 upward or downward to apply or release the pressing against the pelvic floor muscle P.

According to another aspect of the invention, there is provided a pelvic floor muscle strengthening device, wherein the control module 45 controls the force or compression against the user's pelvic floor muscle P to increase proportionally with the proportional constant ranged from 6% to 30% of the user's body weight.

According to another aspect of the invention, there is provided a pelvic floor muscle strengthening device, wherein the control module 45 controls the force or compression against the user's pelvic floor muscle P to reduce inverse-proportionally with the proportional constant ranged from 4% to 20% of the user's body height.

According to another aspect of the invention, there is provided a pelvic floor muscle strengthening device, wherein the device further includes an abdomen belt 12 fastened around the waist of the user, and an abdomen pressure sensor 13 mounted on the abdomen belt 12 for detecting the infra-abdomen pressure of the user and transmitting the detected signal to the electronic circuitry 32, so that the increasing of the abdomen pressure during exercise can be monitored through the display means 60.

According to another aspect of the invention, there is provided a pelvic floor muscle strengthening device, wherein the detecting means 35 comprises of the first sensor 36 and the second sensor 37 disposed on the bearing element 20 along the longitudinal direction with a predetermined interval.

According to another aspect of the invention, there is provided a pelvic floor muscle strengthening device, wherein the display means 60 further includes a sitting position guide means 63 to indicate how to seat on the proper position on the bearing element 20 along the longitudinal direction based on the data detected by the first sensor 36 and the second sensor 37 According to another aspect of the invention, there is provided a pelvic floor muscle strengthening device comprising:
a seat body 11 to be sat by a user;
a bearing element 20 provided on the seat body 11 and having a slender shape to be sat down by the user to push the pelvic floor muscle P upward through the narrow perineal space between the buttocks of the user and having an inclined surface 22 which progressively ascends or descends along the longitudinal direction;
a detecting means 35 installed under the bearing element 20 to detect the force or compression by the bearing element 20 against the pelvic floor muscle P or to detect the force or compression increased by user's contracting of the pelvic floor muscle P;
an electronic circuitry 42 connected to the detecting means 35 and transmitting data of the increased force or compression according to contraction of the pelvic floor muscle P of the user to a display means 60 to display visually or audibly; and
a sitting position guide means 63 which is displayed on the display means 60 and indicates how to seat on the proper position of the bearing element 20 along the longitudinal direction based on the data detected by the first sensor 36 and the second sensor 37.

According to the other aspect of the invention, there is provided a pelvic floor muscle strengthening device, wherein seat position guide means 63 is to guide the sitting position in the manner that the more the user's body weight increases, or the body height reduces, the more the force or compression against the pelvic floor muscle P increases accordingly.

According to another aspect of the invention, there is provided a pelvic floor muscle strengthening device comprising:
a seat body 11 to be sat by a user;
a bearing element 20 provided on the seat body 11 and having a slender shape to be sat by the user to push the pelvic floor muscle P upward through the narrow perineal space between the buttocks of the user;
a detecting means 35 connected to the bearing element 20 to detect the force or compression by the bearing element 20 against the pelvic floor muscle P or to detect the force or compression increased by user's contracting of the pelvic floor muscle P;
an abdomen belt 12 put on around the waist of the user;
an abdomen pressure sensor 13 installed on the abdomen belt 12 for detecting the infra-abdomen pressure of the user;
and an electronic circuitry 42 connected to the detecting means 35 and the abdomen pressure sensor 13 to transmit to the display means 60 to display the information about the contraction of the pelvic floor muscle P and the rising of the infra-abdomen pressure.

According to an aspect of the invention, there is provided a pelvic floor muscle strengthening device comprising:
a bearing element 20 provided on the seat body 11 and having a slender shape to be sat by the user to push the pelvic floor muscle P upward through the narrow perineal space between the buttocks of the user;
a first electrode 70 and a second electrode 71 disposed on the upper surface of the bearing element 20 spaced apart to each other longitudinally to apply electric stimulus to the pelvic floor muscle P of the user;
an electronic circuitry 42 connected to the first and the second electrodes 70, 71 to apply electric stimulus;
a wet tissue 80 releasably covered on the first and the second electrodes 70, 71 to transmit the electric stimulus to the user's body by wetting the clothes even though the user wears the clothes.

According to an aspect of the invention, there is provided a pelvic floor muscle strengthening device, wherein the percentage of moisture content is ranged from 40% to 85%.

According to an aspect of the invention, there is provided a pelvic floor muscle strengthening device, wherein the water tissue 80 has a slender shape corresponding to the shape of the bearing element 20, so that it can wet around the perineal region of the user as small as possible.

### Advantageous Effect

According to the invention, considering that as the pelvic floor muscle P ordinarily supports the organs such as bladder and rectum and others, and the weight of these organs is ordinally proportional to the body weight, if the user's body weight increases, the pressing force against the pelvic floor muscle P also increases proportionally during the pelvic floor muscle exercise, then the user should exercise the contraction of the pelvic floor muscle P more strongly to support the increased weight and achieve restoration of muscle power.

And, in case of the same body weight, the teller the user's height is, the thinner she is in body shape. And the thinner she is, the more she is sensitive to external stimulus and feels pains intensively. Therefore, the pressing force against the pelvic floor muscle P should be applied in inversely proportional to the height of the user to achieve a comfort exercise without reduced pains. That is, according to the invention, the effective pelvic floor muscle exercise is possible with the optimal pressing force against the pelvic floor muscle P which is adjustable in proportion to the user's body weight and in inversely proportional to the pain causing probability.

And, as shown in FIGS. 2 and 3, when the user sits on the bearing element 20, the first sensor 36 and the second sensor 37 respectively disposed on the front and rear end of the bearing element 20 can detect the loads, and the loads should be compared to determine the user's sitting position, so it can guide the proper or optimal sitting position.

And, as shown in FIG. 3, the press-adjusting means 21 using the inclined surface 22 of the bearing element 20 is advantageous in that the optimal pressing force against the pelvic floor muscle P can be is attained only by moving the sitting position according to the guidance of the sitting position guide means 64 by calculating the optimal pressing force based on the body weight and height of the user, which is more simple in structure and cost-down than the lifting type bearing element 20. And the force or compression applied against the bearing element 20 is directly transmitted to the detecting means 35 without passing through the lifting means 30 or others, so that unnecessary interference with other parts while transmitting the force and compression can be reduced and the accuracy of the detection can be enhanced.

And, as shown in FIG. 6, as the abdomen belt 12 having the abdomen pressure sensor 13 is provided, it can be monitored whether the infra-abdomen pressure increases or not during the contraction exercise of the pelvic floor muscle P, so that the accurate Kegel exercise is possible only by using the pelvic floor muscle P without applying force on the abdomen.

And, as shown in FIG. 7, the first and the second electrode 70, 71 are provided on the upper surface of the slender bearing element 20, and a wet tissue 80 moisturized by water is covered on it, and the user can sit on the bearing element 20 without undressing, then the clothes is wetted by the wet tissue 80 so the electric stimulus can be transmitted from the electrodes 70, 71 through the wet clothes to the user skin, which is advantageous in that the user can stimulate electrically the pelvic floor muscle P conveniently without undressing.

And, as the wet tissue 80 is formed or folded as a slender shape corresponding to the shape of the bearing element 20, it can wet only narrow space of the perineal region of the user between the buttocks as small as possible, and as the narrow wet part of the clothes corresponding to the perineal region is almost concealed by the legs when the user stands, so it can be conveniently used without mental burden.

### DESCRIPTION OF THE DRAWINGS

FIG. 1 is a perspective of one embodiment of the invention.

FIG. 2 is a section taken along line A-A′ of FIG. 1

FIG. 3 is a section showing another embodiment of the press-adjusting means of the invention,

FIG. 4 is an operational view of the sitting position guide means of the invention.

FIG. 5 is an operational view main part of the invention.

FIG. 6 is an operational view of the abdomen belt of the invention.

FIG. 7 is an exploded view of another embodiment of the invention.

FIG. 8 is a section taken along line B-B′ of FIG. 7

### DETAILED DESCRIPTION OF THE INVENTION

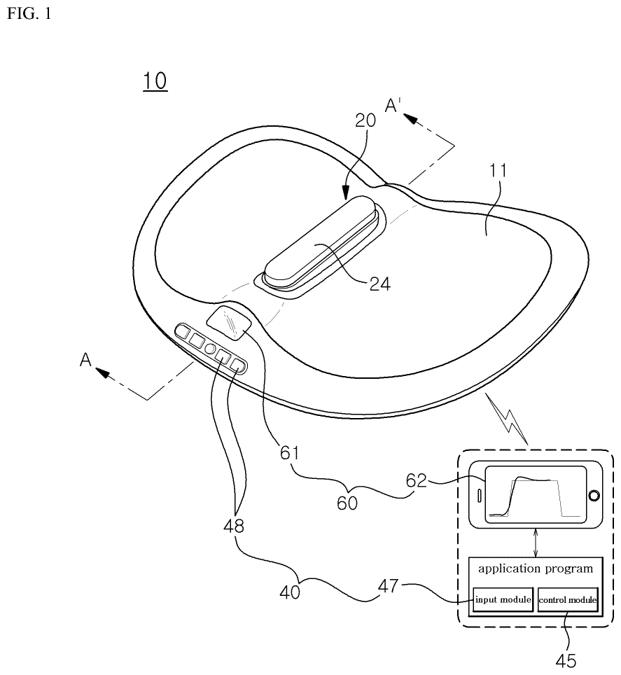

Hereinafter, the preferred embodiments of the invention will be described with reference to the drawings. FIG. 1 to FIG. 8 show various embodiments of the invention. As shown in FIG. 1, the pelvic floor muscle strengthening device includes a seat body 11 in the shape of sitting cushion, a bearing element 20 of the shape of the long bar disposed longitudinally along the front and rear direction on the central part of the seat body 11, operational buttons 48 and a window 61 at the front of the bearing element 20.

The seat body 11 can be such a cushion mat or a chair on which the user can sit on, and the bearing element 20 is a slender protrusion which can access the pelvic floor muscle of the user when the user sits on the seat body 11 through the narrow perineal region between the buttocks, and a cushion sheet 24 covers it.

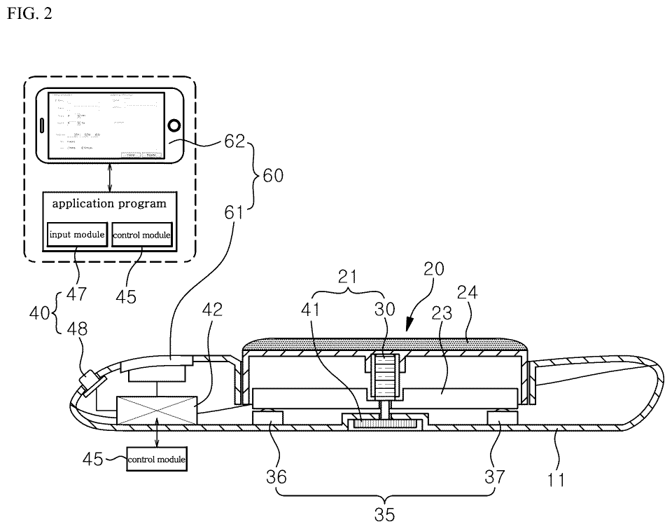

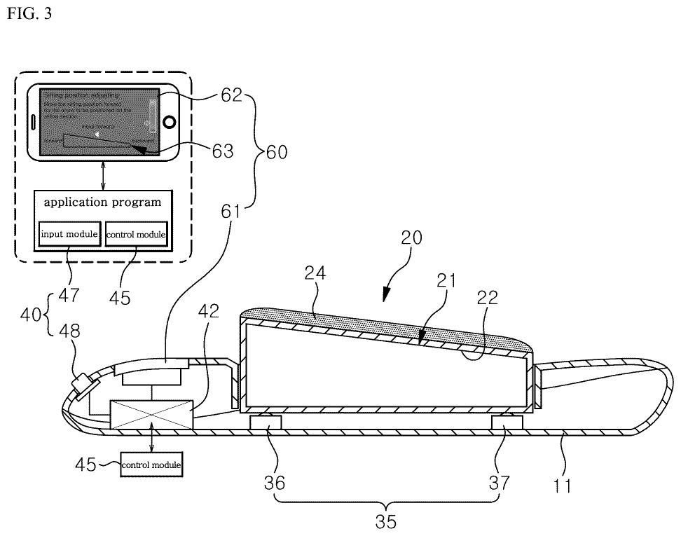

As shown in FIG. 2 and FIG. 3, a press-adjusting means 21 is provided on the central part of the seat body 11 to adjust the force or compression applied by the bearing element 20 against the pelvic floor muscle of the user, that press-adjusting means 21 can be either the lifting type in which the lifting means 30 moves up and down the bearing element 20 in FIG. 2 or an inclined surface type in which the bearing element 20 has an inclined surface and the pressing strength can be adjusted according to the sitting position of the user on the bearing element 20.

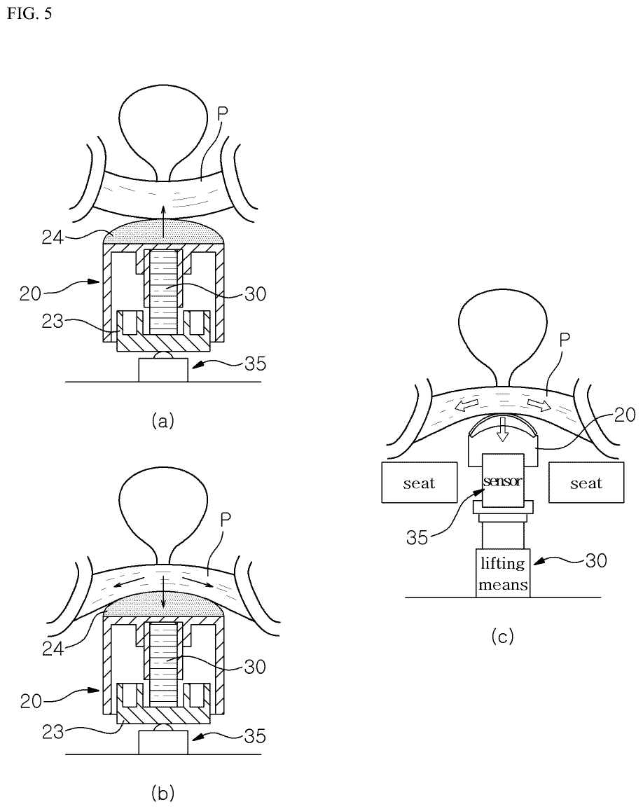

The lifting type press-adjusting means includes a bearing element 20 disposed on the center of the seat body 11 horizontally, and a lifting means 30 such as a vertical screw or a vertical actuator provided under the bearing element 20 as shown in FIG. 5a to 5c, and by adjusting the height of the bearing element 20, the pressing strength against the pelvic floor muscle P can be adjusted. The lifting means 30 can be manually adjusted by turning the handle 41 connected to the screw shaft as shown in FIG. 2, or automatically adjusted by motor not shown through the control module 45. A load transferring bar 23 can be provided horizontally on the lower end of the lifting means 30 to transfer the load applied on the bearing element 20 to the first sensor 36 and the second sensor 37.

The inclined surface type adjusting means comprises of the inclined surface 22 of the bearing element 20, in which the height of the bearing element 20 ascends progressively toward the front end of it as shown in FIG. 3, so if the user moves forward, the height of the bearing element 20 increases and the pressing force against the pelvic floor muscle P also increases, and if the user moves backward, the height of the bearing element 20 decreases and the pressing force against the pelvic floor muscle P also decreases. Alternatively, the height pf the bearing element 20 can increase toward the rear end of it, then the pressing force will decrease toward the rear end of it. The bearing element 20 of this type will not have any lifting means, but the first sensor 3 and the second sensor 37 are installed on the front and the rear end of it to detect the force or compression transmitted through the bearing element 20.

The detecting means 35, as shown in FIG. 2 or FIG. 3, comprises of the first sensor 36 and the second sensor 37 disposed on the front and rear end of the bearing element 20 respectively, and it can detect the force or compression exerted to the pelvic floor muscle P through the bearing element 20, and detect the increasing force or compression according to the muscle contraction when the user exercise the contraction of the pelvic floor muscle P and display it through the display means 60. For example, suppose when the user sits on the bearing element 20, 10 kg is applied on the pelvic floor muscle P, and if the user exercise contraction of the pelvic floor muscle P, the load applied on the detecting means 35 increases from 10 kg to 13 kg, then the increased force by contraction exercise is 3 kg, and the incremental value of 3 kg is displayed through the display means 60.

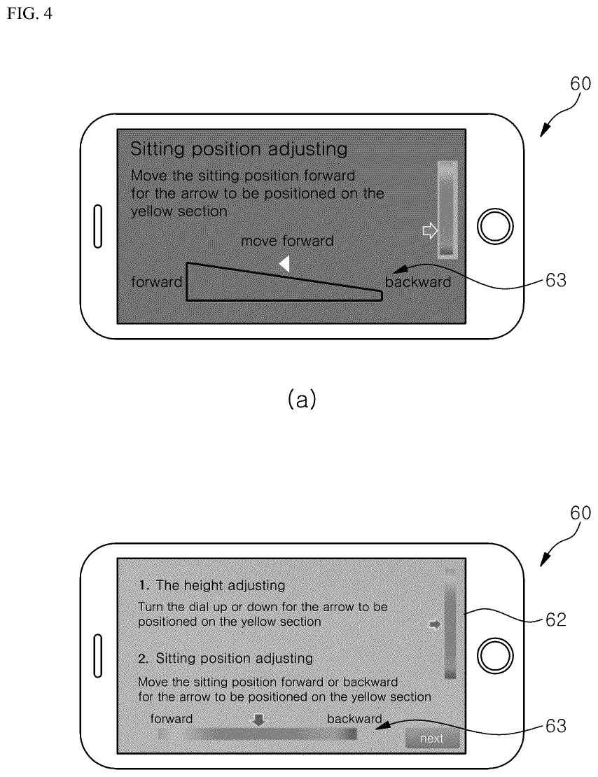

As shown in FIGS. 4a and 4b, the information about the sitting position or the height of the bearing element 20 can be displayed by graphs so that the user can easily adjust the optimal sitting position or the optimal height of the bearing element 20.

As shown in FIG. 4a, as the bearing element 20 has an inclined surface, the pressing force against the pelvic floor muscle will be changed according to the sitting position. If the pressing force is weak, then the user moves forward on the bearing element 20, and if the pressing force is strong, then the user moves backward on the bearing element 20. Then data of the optimal pressing force against the pelvic floor muscle P can be calculated based on the body weight and height of the user, and the optimal pressing force should be proportional to the body weight and inversely proportional to the height of the user. The sitting position guide means 63 is provided on the display means 60, and if the actual pressing force applied on the pelvic floor muscle P through the bearing element 20 is weaker than the calculated optimal pressing force, then it displays a message to move forward, and if the actual pressing force is stronger than the calculated optimal pressing force, then it displays a message to move backward.

As shown if FIG. 4b, if the bearing element 20 is disposed horizontally, the pressing force against the pelvic floor muscle P is adjusted by up/down of the lifting means 30, and the optimal sitting position is obtained by judging how much the sitting position is biased based on the load data detected by the first sensor 36 and the second sensor 37, so it can guide the optimal sitting position of the bearing element 20.

As for the height adjusting of the bearing element 20 by the lifting means 30, the optimal pressing force data is calculated by use of the information of the body weight and height of the user, then height of the bearing element 20 is adjusted by the lifting means 30 to press the pelvic floor muscle P until it reaches the optimal pressing force. If the data of the weight and height of the user are input through the body information input means 40, the optimal pressing force is calculated, which is proportional to the weight and inversely proportional to the height, and it is applied to the pelvic floor muscle P (shown in FIG. 5), then the effective and proper exercise of muscle contraction of the pelvic floor muscle can be carried out like a dumbbell arm exercise.

That is, the pelvic floor muscle ordinarily supports the pelvic organs such as bladder and rectum, and the weight of these pelvic organs is ordinarily proportional to the body weight. Therefore, for exercise of contraction of the pelvic floor muscle P, it is necessary to press the pelvic floor muscle P with the force proportional to the body weight of the user to restore the muscle strength of the pelvic floor muscle enough to support the weight of the pelvic organs sufficiently.

If the body weight is equal, the higher the height of the user is, the thinner the body shape is, and generally the user of thin body shape feels pains more strongly because she has less muscle. Therefore, the strength of the external resistance applied against the pelvic floor muscle P should be reduced in inversely proportional to the user's height to achieve a comfort exercise with low pain causing probability.

It is found through experiments that the contracting exercise with a proper pressing force against the pelvic floor muscle P is possible if the proportional constant ranged from 6% to 30% of the body weight is applied. If it is lower than 6%, the external resistance is too low to achieve a meaningful exercise, and if it is higher than 30%, it is too painful to keep exercising.

It is also found through experiments that the contracting exercise with a proper pressing force against the pelvic floor muscle P is possible if the proportional constant ranged from 4% to 20% of the body height is applied inverse-proportionally. If it is lower than 4%, it is too painful, and if it is higher than 20%, the external resistance is too low to achieve a meaningful exercise.

The invention as described above, differently to the conventional insert type treatment device of urinary incontinence with non-load muscle training, can apply an optimal external resistance necessary to the exercise of pelvic floor muscle P, and the user can effectively exert the contracting force on the pelvic floor muscle in resistance to the external resistance, so the treatment effect can be highly improved.

According to the invention, the device could push up the normally sagged pelvic floor muscle P by the weight of pelvic organs such as a bladder and a rectum in U shape as shown in FIG. 5a by the bearing element 20 to reverse into n shape as shown in FIG. 5b, and the user exercises contracting the pelvic floor muscle P as shown in FIG. 5c, then the vertical component of the contracting force applied on the bearing element 20 is detected by the detecting means 35 below the bearing element 20, so the degree of contracting of the pelvic floor muscle P can be detected. That is, as the pelvic floor muscle P is normally sagged in U shape, it was difficult to detect the contracting force of the pelvic floor muscle P from outside the body. But according to the invention, the pelvic floor muscle P is pushed up to reverse into n shape, and if the muscle contracts, then the vertical component of the contracting force will press down the bearing element 20, so the contracting force of the pelvic floor muscle P can be easily detected from outside the body.

As shown in FIGS. 2 and 3, the electronic circuitry 42 receives the pressing force signal from the detecting means 35, filtering and amplifying it, and transmits it to the display means 60, and controls the operation of the device through the embedded control module 45.

The input means 40 is provided to input the information about the body weight and height of the user, it can be an input button 45 installed on the front part of the seat body 11, or it can be an input module 47 installed on the external device such as smart phone or PC. In case of the external input module 47, the application program installed on the external device includes the interface display information through which the data of body weight and height can be input.

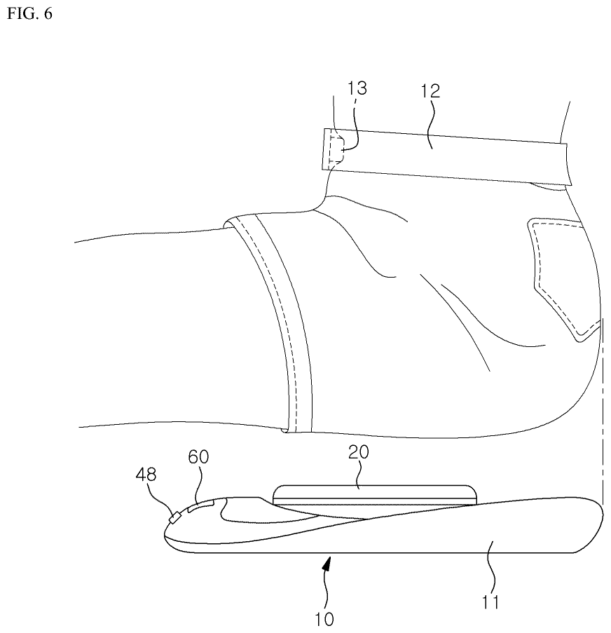

The control module 45 is built in the electronic circuitry 42 inside the device or stored on the external application program to control the device, and one of the control operation is to receive the information of the body weight and height of user, and generate control signal such that the more the body weight of the user increases, the more the pressing force against the pelvic floor muscle P increases, and the more the height of the user increase, the more the pressing force against the pelvic floor muscle P decreases, As shown in FIG. 6, the invention further includes an abdomen belt 12 to be fastened around the user waist, and an abdomen pressure sensor 13 is mounted on the abdomen belt 12. This abdomen sensor 13 detects whether the infra-abdomen pressure of the user increases or not while the user exercises contracting of the pelvic floor muscle P, and displays it through the display means 60 for user's monitoring, so that it can induce the correct Kegel exercise in which only the pelvic floor muscle P can be contracted without exerting on the belly.

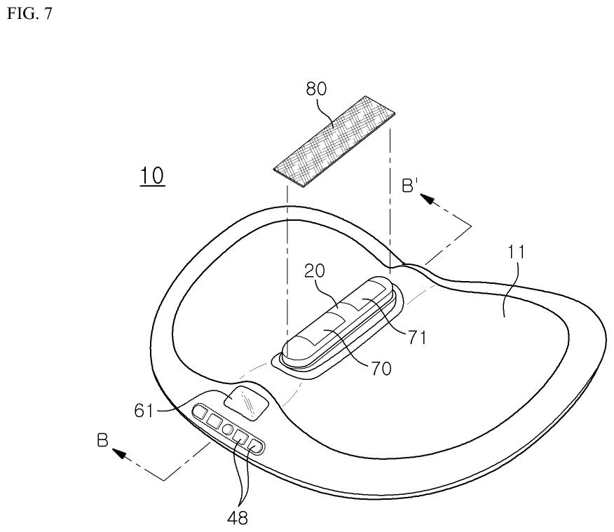

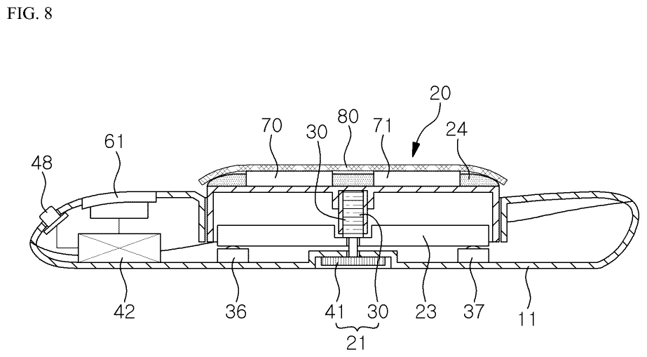

According to the other embodiment of the invention, the user can exercise the pelvic floor muscle P passively while wearing the clothes by applying electric stimulus on the pelvic floor muscle P, which will be described with reference to FIGS. 7 and 8. According to the invention, at least two electrodes including the first electrode 70 and the second electrode 71 spaced apart to each other along the longitudinal direction are provided on the upper surface of the bearing element 20, and it can be three or more electrodes, and the electronic circuitry 42 includes an electric stimulus generator to generate low or middle frequency waves, and this electronic circuitry 40 generates an electric stimulus of frequency from 5 Hz to 3,000 Hz and transmit it to the user body through the electrodes 70, 71.

Preferably, the bearing element 20 is in the slender shape with the width being from 12 mm to 39 mm and the length being from 40 mm to 250 mm, so it can press the pelvic floor muscle in the pelvis through the narrow space between the buttocks or hipbones.

A wet tissue 80 moisturized by water is provided on the bearing element 20 to cover the first electrode 70 and the second electrode 71. The wet tissue 80 is formed or folded in the slender shape corresponding to the bearing element 20, and preferably with the width being from 15 mm to 50 mm and the length being from 50 mm to 250 mm, so it can wet the least area of the perineal region of the user which is almost concealed from outside. The percentage of moisture content of the wet tissue 80 is preferably ranged from 40% to 85%, so that it can contain sufficient moisture and can wet the user's clothes to effectively transmit the electric stimulus through the wet clothes to the skin of user while the user wears the clothes. The wet tissue 80 may be disposable or it can be used repeatedly by washing or steaming. If the wet tissue 80 is made or folded in the slender shape corresponding to the bearing element 20, the wet area of the clothes can be reduced, and when the user stands after using the device, the wet perineal region is concealed by the legs and the user can walk around with easy mind.

Meanwhile, if the first electrode 70 and the second electrode 71 are disposed in the width direction, the electrodes would butt into the hipbones and it cannot access the pelvic floor muscle P, so it cannot transmit the electric stimulus to the pelvic floor muscle P effectively. And if the electrodes are disposed in the width direction, the buttocks may be wetted and it could be exposed outside to incur humiliation,

The scope of the invention as described above will not be restricted by the embodiments and the accompanying drawings, and various modifications, changes and transform can be possible without departing the technical ideas of the invention.

1. A pelvic floor muscle strengthening device comprising:
a seat body 11 to be sat by a user;
a bearing element 20 provided on the seat body 11 and having a slender shape to be sat by the user to push the pelvic floor muscle P upward through the narrow perineal region between the buttocks of the user;
a press-adjusting means 21 to adjust the force or the compression to press the pelvic floor muscle P of the user through the bearing element 20;
a detecting means 35 connected to the bearing element 20 to detect the force or compression by the bearing element 20 against the pelvic floor muscle P or the force or compression increased by user's contracting of the pelvic floor muscle P;
an electronic circuitry 42 connected to the detecting means 35 and transmitting data of the increased force or compression according to contraction of the pelvic floor muscle P of the user to a display means 60 to display visually or audibly;
an input means 40 to input the information of the user's body weight;
a control module 45 to receive the information of the user's body weight and generate a control signal to increase the force or compression applied on the pelvic floor muscle P in proportion to the user's body weight, so that;
the device can be exercised in the manner that if the user's body weight increases, the weight of the pelvic organs also increases proportionally, so the force or compression pressing on the pelvic floor muscle P also increases to achieve more effective contracting exercise.

2. A pelvic floor muscle strengthening device of claim 1, wherein the input means 40 can be input an information of user's body height, and the control module 45 can generate a control signal which, if the user's body height increases, the force or compression pressing on the pelvic floor muscle P is reduced inverse-proportionally.

3. A pelvic floor muscle strengthening device of claim 1, wherein the press-adjusting means 21 comprises of an inclined surface 22 of the bearing element 20 which is inclined longitudinally, so that as the user moves the sitting position longitudinally, the pressing intensity of the bearing element 20 can be adjusted.

4. A provided a pelvic floor muscle strengthening device of claim 1, wherein the press-adjusting means 21 includes a lifting means 30 of the bearing element 20, which can move the bearing element 20 upward or downward to apply or release the pressing against the pelvic floor muscle P.

5. A pelvic floor muscle strengthening device of claim 1, wherein the control module 45 controls the force or compression against the user's pelvic floor muscle P to increase proportionally with the proportional constant ranged from 6% to 30% of the user's body weight.

6. A pelvic floor muscle strengthening device of claim 1, wherein the control module 45 controls the force or compression against the user's pelvic floor muscle P to reduce inverse-proportionally with the proportional constant ranged from 4% to 20% of the user's body height.

7. A pelvic floor muscle strengthening device of claim 1, wherein the device further includes an abdomen belt 12 fastened around the waist of the user, and an abdomen pressure sensor 13 mounted on the abdomen belt 12 for detecting the infra-abdomen pressure of the user and transmitting the detected signal to the electronic circuitry 32, so that the increasing of the abdomen pressure during exercise can be monitored through the display means 60.

8. A pelvic floor muscle strengthening device of claim 1, wherein the detecting means 35 comprises of the first sensor 36 and the second sensor 37 disposed on the bearing element 20 along the longitudinal direction with a predetermined interval.

9. A pelvic floor muscle strengthening device of claim 8, wherein the display means 60 further includes a sitting position guide means 63 to indicate how to seat on the proper position on the bearing element 20 along the longitudinal direction based on the data detected by the first sensor 36 and the second sensor 37

10. A pelvic floor muscle strengthening device comprising:
a seat body 11 to be sat by a user;
a bearing element 20 provided on the seat body 11 and having a slender shape to be sat down by the user to push the pelvic floor muscle P upward through the narrow perineal space between the buttocks of the user and having an inclined surface 22 which progressively ascends or descends along the longitudinal direction;
a detecting means 35 installed under the bearing element 20 to detect the force or compression by the bearing element 20 against the pelvic floor muscle P or to detect the force or compression increased by user's contracting of the pelvic floor muscle P;
an electronic circuitry 42 connected to the detecting means 35 and transmitting data of the increased force or compression according to contraction of the pelvic floor muscle P of the user to a display means 60 to display visually or audibly; and
a sitting position guide means 63 which is displayed on the display means 60 and indicates how to seat on the proper position of the bearing element 20 along the longitudinal direction based on the data detected by the first sensor 36 and the second sensor 37.

11. A pelvic floor muscle strengthening device of claim 10, wherein seat position guide means 63 is to guide the sitting position in the manner that the more the user's body weight increases, or the body height reduces, the more the force or compression against the pelvic floor muscle P increases accordingly.

12. A pelvic floor muscle strengthening device comprising:
a seat body 11 to be sat by a user;
a bearing element 20 provided on the seat body 11 and having a slender shape to be sat by the user to push the pelvic floor muscle P upward through the narrow perineal space between the buttocks of the user;
a detecting means 35 connected to the bearing element 20 to detect the force or compression by the bearing element 20 against the pelvic floor muscle P or to detect the force or compression increased by user's contracting of the pelvic floor muscle P;
an abdomen belt 12 put on around the waist of the user;
an abdomen pressure sensor 13 installed on the abdomen belt 12 for detecting the infra-abdomen pressure of the user;
and an electronic circuitry 42 connected to the detecting means 35 and the abdomen pressure sensor 13 to transmit to the display means 60 to display the information about the contraction of the pelvic floor muscle P and the rising of the infra-abdomen pressure.

13. A pelvic floor muscle strengthening device comprising:
a bearing element 20 provided on the seat body 11 and having a slender shape to be sat by the user to push the pelvic floor muscle P upward through the narrow perineal space between the buttocks of the user;
a first electrode 70 and a second electrode 71 disposed on the upper surface of the bearing element 20 spaced apart to each other longitudinally to apply electric stimulus to the pelvic floor muscle P of the user;
an electronic circuitry 42 connected to the first and the second electrodes 70, 71 to apply electric stimulus;
a wet tissue 80 releasably covered on the first and the second electrodes 70, 71 to transmit the electric stimulus to the user's body by wetting the clothes even though the user wears the clothes.

14. A pelvic floor muscle strengthening device, of claim 13, wherein the percentage of moisture content is ranged from 40% to 85%.

15. A pelvic floor muscle strengthening device of claim 13, wherein the water tissue 80 has a slender shape corresponding to the shape of the bearing element 20, so that it can wet around the perineal region of the user as small as possible.
